(19) United States
(12) Patent Application Publication
(10) Pub. No.: US 2008/0174863 A1
(43) Pub. Date: Jul. 24, 2008

(54) Star Identification and Alignment System

(76) Inventor: Mark S. Whorton, Big Cove, AL (US)

Correspondence Address: NASA/MARSHALL SPACE FLIGHT CENTER, LSO1/OFFICE OF CHIEF COUNSEL, MSFC, AL, 35812, US

(21) Appl. No.: 11/626,573

(22) Filed: Jan. 24, 2007

(51) Int. Cl. G02B 23/00

(52) U.S. Cl. 359/430

(57) ABSTRACT

Autonomous operation of ground telescope and CCD imaging systems is a highly desirable mode of conducting amateur and professional astronomy. Many current systems allow remote operation to some degree, but no commercial system permits complete autonomous operations suitable for precise pointing and imaging. In particular, the initial alignment of the telescope to the celestial coordinates is a manual operation for all but the highest end commercial systems. Even for the systems that permit a crude automatic initial alignment, operational alignments require manual intervention.

### STATEMENT OF GOVERNMENT INTEREST

This invention was made by the National Aeronautics and Space Administration, an agency of the United States Government. Therefore, the United States Government has certain rights in this invention.

### BACKGROUND

The prior art telescope systems utilize a manual two-star initialization process (with one exception noted below). The initialization process begins with the user selecting a known target from a list of initialization stars and manually centering the object in the telescope field-of-view (FOV). Once the target has been acquired, a manual keystroke entry on the telescope/mount hand controller is used to notify the telescope control system that the current orientation corresponds to the reference celestial coordinates. After the right ascension and declination (hereinafter RA and Dec) of two or more stars are identified with the corresponding telescope drive angles, the transformation between the telescope drive axis angles and celestial coordinates is computed by the telescope control software. The most recent development in COTS telescopes incorporates a GPS sensor into the telescope along with a magnetic compass to facilitate automation or at least simplification of the initialization process. Assuming that reference drive axis angles are stored in memory, the telescope can integrate the GPS data, compass data, and reference drive angles for a rough automatic alignment.

Operational alignment updates are required periodically to remove the accumulated pointing error after successive slews. The typical field of view for COTS CCD camera is quite limited so it is common for the target to not be in the FOV after a long slew (or several slews). This potentiality is inadequately addressed in the prior art by periodically updating the alignment on stars that are successfully acquired. The relationship between telescope drive angles and celestial coordinates is also determined by some user interface software packages (such as TheSky by Software Bisque). These packages are run remotely from the telescope drive system and the CCD camera as an interface for the user that coordinates the operations of the various systems. Where alignment estimates are computed by the interface software, encoders on the drive axes provide telescope pointing angles to the remote software and the user identifies the corresponding star field in the field of view (with known celestial coordinates). If this data is known for two different pointing angles, then the transformation can be computed.

At least one current user interface software package (TheSky by Software Bisque) provides a pattern recognition capability. An estimate of the field of view is manually entered along with an image of the current star field and the software will align the image with a corresponding virtual image of the estimated field of view. This limited alignment from image data matches the patterns in the image with a virtual image if the user provides a close initial estimate and the virtual image is appropriately scaled and rotated to closely align with the reference CCD image.

Some commercial star trackers used for spacecraft applications perform a “lost-in-space” star identification from which the spacecraft attitude is determined, but that technology has not been fielded in ground telescopes and differs in some key details.

Current commercial systems telescopes perform the initialization process through the user manually centering a known object and entering a command to the telescope indicating the object is centered. In most cases of remote operation, the remote observer will acquire a mosaic of images and then manually inspect the image to determine (from the user's knowledge of the sky) where the telescope is pointed. This is a time consuming process that depends on the knowledge and skill of the user.

A recent development in commercial telescopes incorporates a GPS sensor into the telescope along with a magnetic compass to facilitate automation or at least simplification of the initialization process. However, this initial alignment is not accurate enough to ensure that a target will be centered in the FOV after a slew to the target and hence additional manual alignment is required for precise initialization. Even if the initial alignment is exact, intermediate re-initialization is required to remove the pointing error from subsequent slew maneuvers.

The typical field of view for commercial CCD camera is quite limited so it is common for the target to not be in the FOV after a long slew (or several slews). This potentiality is mitigated by periodically updating the alignment on stars that are successfully acquired. This presents a significant limitation for autonomous operations though because if the target star is not in the FOV after a slew, then it is essentially “lost-in-space.”If the telescope aligns on the wrong star in the FOV, then there will be a fixed misalignment that will likely lead to a “lost-in-space” condition. If an autonomous telescope becomes “lost-in-space,” the system will either terminate the schedule or a sophisticated re-initialization procedure must be performed which requires non-standard sensors on the telescope.

Operational alignment updates are required periodically to remove the accumulated pointing error after successive slews. The prior art accomplishes operational alignment updates by slewing and aligning the telescope on the target of observation or a pre-selected bright “guide-star” the vicinity of the target (if the target is not a bright star). Success of this intermediate alignment update depends on the selection and acquisition of appropriate guide-stars for selected targets (if the target is not a bright star). The user must anticipate when the pointing errors necessitate an alignment update and select appropriate guide-stars as scheduled targets. Guide-star selection is a tedious and time-consuming process that is not for the novice amateur astronomer.

Successful operational alignment also assumes acquisition of that guide-star after a slew. The typical field of view for commercial CCD cameras and other standard image capture devices are quite limited so it is common for the target to not be in the FOV after a long slew (or several slews). If the guide-star is not in the FOV, the update will fail and the telescope will be “lost in space.” Alternatively, if the telescope aligns on the wrong star in the FOV then there will be a fixed misalignment that will likely lead to a “lost-in-space” condition. If an autonomous telescope becomes “lost-in-space,”the system will either terminate the schedule or a sophisticated re-initialization procedure must be performed (GPS based automated alignment is of no value for an operational alignment update when the image is not in the FOV) which requires non-standard sensors on the telescope. This potential deficiency can only be overcome in an autonomous system by implementing star identification for alignment updates.

An additional significant deficiency in the prior art is that it requires additional hardware components beyond the telescope and CCD camera such as a GPS sensor, magnetic compass, digital inclinometer to measure level, or absolute encoders on the drive axes. The vast majority of observers are not thusly equipped. Hence, the limited initial (albeit rough) alignment capability using the prior art is limited to only specially equipped, high-end telescopes. The innovation disclosed herein requires only a computer controlled telescope and CCD camera. As used herein, “telescope” should be understood as a telescope that uses a computer driven pointing system (or computer driven telescope mount, computer controlled telescope, or “Go-To Telescope” in the common vernacular). In other words, each embodiment of this invention presumes that a computer processor issues commands to the two telescope drive axes. It is implicit in the title and description, but this invention does not apply to a mere telescope alone as in an optical telescope/tube assembly only. That distinction is made explicit in several places, but we should not leave the impression that a bare telescope is all that is required as if the computer driven pointing system is not a necessary component.

The prior art in user interlace software has a feature that performs an alignment estimate from a star image. Rather than identifying the stars in the image field, this alignment process essentially matches patterns of bright stars in two images: one, a virtual image that encompasses the estimated FOV of the CCD image; and the other, a CCD image of the current telescope FOV. This procedure does not try to uniquely associate objects in the CCD image with a database of stars but rather aligns two images, one of which is derived from a database. This prior art is limited by a dependence on a close initial guess of the telescope field of view (within a few degrees), the proper scaling and rotation of the CCD image. To summarize, the prior art is not autonomous (is a manual procedure) nor is it general enough for an unaided initial alignment. Finally, the prior art for ground applications does not allow for a stand-alone autonomous star identification process that could be implemented in CCD camera control software or interfaced directly with the telescope mount.

With regard to star tracker prior art used for lost-in-space star identification in spacecraft applications, that technology is not pertinent for ground applications. First, star trackers do not have to address seeing reflects such as atmospheric distortion, sky pollution, and cloud/haze cover or changes during the night. These effects cause focus errors as well as apparent scale/factor sensitivity changes (same star, different magnitude at different times). Secondly, star trackers must search the entire celestial sphere without any initial parsing of the data.

### SUMMARY OF THE INVENTION

One embodiment of the present invention provides a method for identifying celestial objects and pointing a telescope. The method steps include providing a telescope and determining initial configuration data of the telescope. Configuration data can take the form of location, potentially provided by a user using, for instance, a zip code, or GPS data. A terrestrially based positioning system which provides location information may also be employed; such a system could use directional signal detectors such as cell phone or commercial transmitters to fix a location. A user may also be permitted to provided latitude and longitude, and local time. Time may also be provided by a terrestrially based system or a satellite based system. Telescope drive angles and RA and Dec. of line of sight may also be provided to assist in determining configuration. A next step is to slew, or point, the telescope to a target orientation. Another step is to capture an image for star identification. This could be done with a CCD, CMOS, or other image capture device. In the interests of brevity, the term CCD may be used herein, but it should be explicitly understood that this is used in lieu of enumerating the various types of image capture devices. Virtually any image capture device will work with the present invention. Therefore the term CCD shall not be construed more narrowly then an image capture device, irrespective of whether the device is a CCD based image capture device. Using the data from the captured image, the next step is to perform a star identification process, utilizing a star field database. Thereafter, relative coordinates are derived from an identified star, and relevant data is provided to the telescope-pointing system and the telescope is pointed based on the provided relative coordinates utilizing the telescope-pointing system.

In another embodiment, the step of slewing the telescope to a scheduled target orientation includes the steps of scheduling two initial target orientations to be initial alignment orientations. These first initial target orientations may be approximately 45 degrees from the horizon in the northwest direction for the first alignment and 45 degrees from the horizon in the northeast direction for the second alignment. The initial target orientations can be commanded based on the a priori knowledge of the parked telescope orientation in terms of right ascension and declination drive axis angles relative to north and the horizon. An additional step may be performed where including an automated focus of the captured image. The star field database is parsed based on the celestial coordinates of the estimated field of view. If the selected FOV does not contain enough data for identification convergence, a mosaic image is acquired with a larger field of view for the search. In an embodiment during the initialization orientations, the size of an initial region of the sky is based on the estimated accuracy of the initial configuration estimates and the size of the initial region includes the actual field of view of the telescope. The image capture device image could also be used to demarcate the initial region of the sky.

In another embodiment the present invention includes an autonomous system for pointing a telescope including an image capture device, a processing and matching protocol, a database, a pointing processor, a pointing control system, a user interface, and a telescope. The image capture device, as described above, is configured to capture an image of at least two celestial objects. It is noteworthy that only one image is required if there are multiple objects in the single image; and is configured to convey that image to the processing and matching protocol, and the image is processed and associated with a unique set of data in the database. The pointing processor processes the unique set of data and a signal from the pointing control system, the signal provides the pointing direction of the image capture device. The pointing processor also relies on the data cleaned for the user input so that the pointing system knows where the user wants the telescope to focus. The output of the pointing processor is sufficient to instruct pointing system to point the telescope toward a predetermined celestial object, or series of celestial objects.

Another embodiment of the present invention provides a control system for pointing a telescope including a telescope control computer, a telescope, an image capture device, a telescope alignment system, a telescope control computer configured to acquire image data from an image capture device, over a serial link for example, and perform a star identification process. This identification process relies on an associated database and identification protocol. A telescope system would perform the alignment update using drive axis sensor data and the identified celestial coordinates of the field of view of the image capture device.

In another embodiment the invention provides a method for providing instruction on the universe comprising the steps of utilizing a processing and matching protocol and a first database to identify a celestial object based on input from an image capture device; and identifying content relevant to said celestial object and delivering the content to a user via a user interface. Naturally, the invention does not have to be restricted to a video interface. Any type of multimedia distribution of the content once the patch of sky being observed is known. It is contemplated that a “robotic astronomy lecturer” might be provided. The telescope would autonomously initiate itself, work its way through some “sky tour” (predetermined according to any number of different teaching objectives), and then broadcast multimedia information content about what is being observed. The image being captured could even be displayed on a large screen monitor while the multimedia information content is simultaneously broadcast. It could work for astronomy day events, museums, university lab classes, etc. An additional option allows a user to input requests, either audibly or through some input device. This embodiment provides a “robotic astronomer” which can respond to observer requests. For example, if an audience member issued an observation request the telescope will point to that object (after finding the data in a database) and then provide the information content to the audience. This is but one embodiment of the innovation, a capability enabled by the autonomous operations, in particular the operational alignment updates that enable multiple observations.

It should be understood that all contemplated user interfaces do not have to be a conventional manual user input at the time of operation. This inventions user interface is merely the means by which the system receives commands and it could be stored data that is executed in some batch configuration, or it could be issued remotely. The user interface does should not be construed to imply that the user need be present or is even needed for interacting with the system. This could be user specified configuration data such as where the telescope is located, telescope specifications, local time to begin operation, etc.

### BRIEF DESCRIPTION OF THE DRAWINGS

FIG. 1 is a system of the present invention; and

FIG. 2 is a flowchart showing a method of the present innovation.

### DETAILED DESCRIPTION

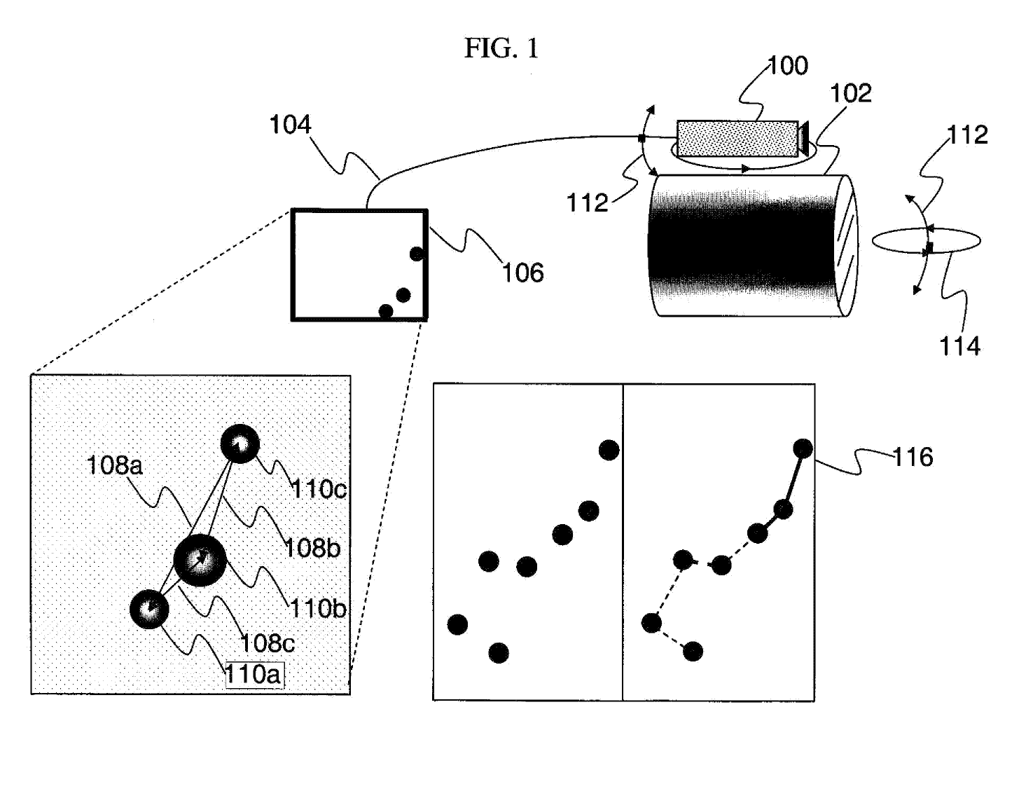

In one embodiment of the present invention, the invention provides a method and system that replaces the need for manual initial alignment process for telescopes with an automated precision alignment process using information gleaned from a star field image 106. The system is illustrated in FIG. 1. The information may be obtained from a CCD or CMOS camera or virtually any other image capture device 100. This image capture device 100 optionally may be coupled to the telescope 102 or situated nearby. In another embodiment, it may be situated a distance away, if the fixed, relative orientation is known. By automating the alignment process, no operator (either at the telescope 102 or at a remote location) is required either for initialization or mid-campaign operational alignment updates. Instead, the CCD camera 100, or other image capture device 100 will provide image 106 data that will be processed to determine the Right Ascension (RA) 114 and Declination (Dec) 112 of bright stars in the image 106. Using a star identification algorithm to determine the celestial coordinates corresponding to the telescope 102 Line-of-Sight (LOS) for two different pointing orientations or from at least two objects in a single image, the telescope 102 will be autonomously initialized and aligned for subsequent automated pointing and tracking. The identified celestial coordinates of the current LOS will be automatically communicated to the telescope 102 control system for automated alignment of the drive axis. If additional information such as latitude, longitude, time (through manual entry or a GPS receiver) and estimated RA 114 and Dec 112 are known (such as after a rough initialization or slew), then the efficiency of the algorithm can be substantially increased by restricting the database search to a known subspace. This process can be repeated whenever needed for autonomous operational alignment updates. In addition to initial alignment, which assumes large errors in the pointing estimate, this operational star identification begins with a more accurate pointing estimate and is used for automated alignment updates after large angle slews to guarantee the target image is centered in the FOV regardless of accumulated pointing errors. The image capture device 100 is shown to convey data via wire 104 but there is no reason that such data could not be conveyed wirelessly.

Immediately after a slew (or a specified number of slews), the star identification process can examine the image 106, identify the objects in the field, and center the telescope 102 on the specified coordinates. This provides a means to autonomously position and track any object in the FOV after a slew. A specified image offset can be tracked as well for deep sky imaging (e.g. autonomously center and track a dim object based on its location). Autonomous operational alignment ensures accurate pointing for each image regardless of the number of stews during an observational campaign.

This innovation improves upon the general lost-in-space identification of star trackers in applying the concept to ground imaging systems in the following manner. Ground applications of star identification are not truly “lost-in-space” as a spacecraft could be because the user will typically have a moderately accurate estimate of the local time, where the telescope 102 is located and where the telescope 102 is initially pointed (such as from a home position). The nominal initialization process would involve a user specified initial slew from a home position, which will permit a reasonable estimate of the pointing orientation to restrict the database search. Note however that star identification can be performed for the worst case where there is no knowledge of where the telescope 102 is pointed. In that case, the database is still smaller than the general star tracker application because the latitude, longitude, and time will restrict the image database to the visible sky from that location. Obviously, if nothing about the time or location is known the database could still identify stars but additional processing time or processing capacity may be required.

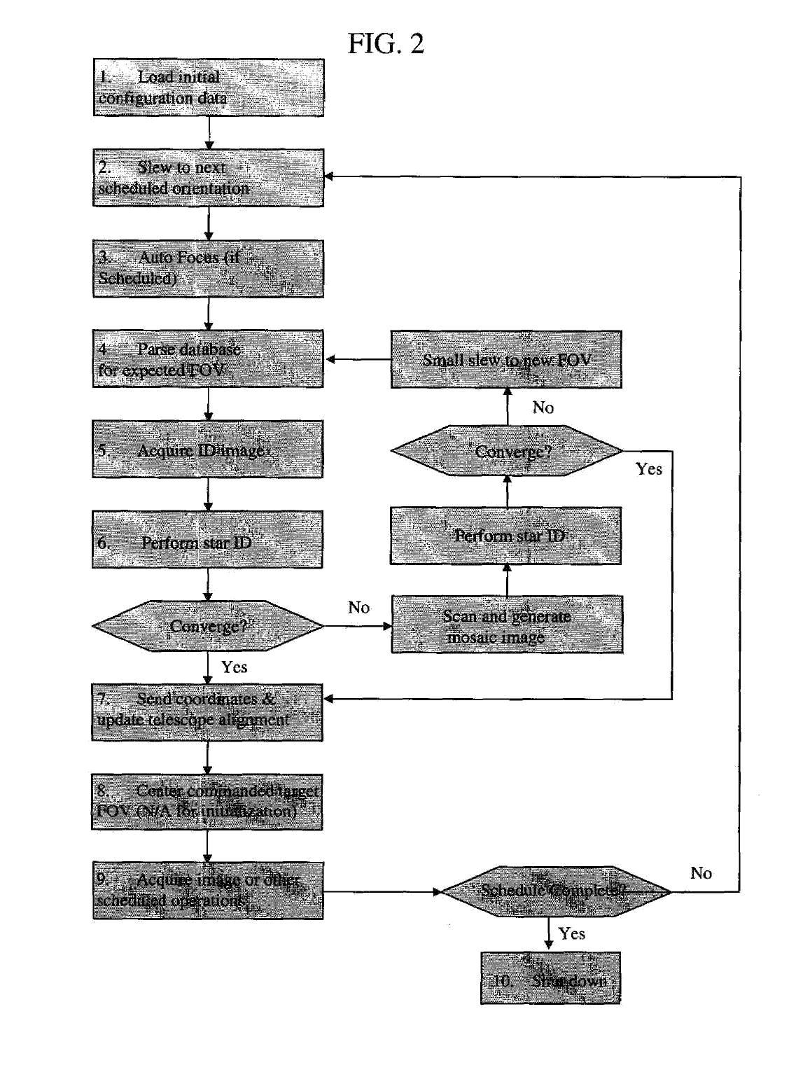

The functional operation of this innovation is illustrated by the flow chart in FIG. 2 where:

1. The initial configuration of the telescope is determined from information provided by the user such as zip code; GPS data; user provided latitude and longitude; local time; estimated telescope drive angles; estimated RA 114 and Dec 112 of LOS (center of field of view); etc. This information is not necessary but depending on the accuracy of the information, this information will significantly increase the efficiency and accuracy of the initial alignment estimate.
2. Slew to the next scheduled (user-specified) target orientation. The first two target orientations scheduled will be initial alignment orientations. In an alternate embodiment initializing may be accomplished using two objects in a single image. For example, the first alignment orientation might be approximately 45 degrees from the horizon in the Northwest direction. The second alignment orientation might be 45 degrees from the horizon in the northeast direction. These orientations can be commanded based on the user's knowledge of the parked telescope orientation in terms of right ascension and declination drive axis angles relative to north and the horizon.
3. Perform an automated focus of the CCD image if scheduled.
4. Parse the star field database based on the celestial coordinates of the estimated FOV. For initialization orientations, the size of this initial region of the sky is based on the accuracy of the initial configuration estimates and it must be large enough to contain the actual FOV. For alignment updates during operations, the estimated LOS will be much more accurate and a smaller search region will suffice (thus increasing the efficiency and accuracy of the star identification).
5. Acquire a CCD image for star identification. The length of integration time will depend on the CCD camera and telescope, but it should be of sufficient time to obtain enough bright stars in the image for identification purposes. This integration time will be user specified in the configuration file or derived from an image capture device and telescope specifications. The specifications of the camera and telescope are generally sufficient to allow one to derive a nominal exposure time.
6. Perform the star identification. If the identification does not converge, then a mosaic image is acquired with a larger FOV for the search. If the star identification does not converge with the larger FOV mosaic image, then the telescope will slew to a different orientation (say 10 degrees in each axis) and the process repeats beginning with step 4. (A user specified limit can be specified for the number of time convergence fails before the process terminates and the telescope is powered down.)

7. After the identification converges, the software will send a signal to the telescope computer indicating the celestial coordinates of the current LOS for an alignment update (or initialization).

8. Null the pointing error (point LOS to target coordinates) and acquire science image or perform other operations (such as filter changes, multiple images, etc) as scheduled. This step is not typically scheduled for initial alignment orientations.
9. If schedule is complete, then shut down the systems. If schedule is not complete, Repeat steps 2 through 10.

There are several potential embodiments of the technology. The processing technology can be implemented in the telescope 102 pointing control system; the CCD camera control system; user interface software; or an independent, stand-alone software application.

If the processing functionality were associated with the telescope 102, the telescope 102 control computer would acquire the image data from the CCD camera 100 (over a serial link for example) and perform the star identification procedure as part of the alignment process. This would shift the computational burden to the telescope 102, but the processor in the telescope control system is quite capable of this task. In this embodiment, the telescope system would perform the alignment update using drive axis sensor data and the identified celestial coordinates of the FOV.

The functionality could also reside in the CCD camera control software. For example, a CCD camera manufacturer could incorporate this function into the CCD camera control software and directly communicate the celestial coordinates of an image to the telescope control system (essentially replacing the manual keystroke entry with a signal containing the coordinates of the LOS). When this embodiment of the present invention is implemented, it can serve as an added feature to CCD camera control systems. It can function as a user aid for identifying the objects in an image 106 (such as asteroid or supernova search surveys).

The function could reside in an interface software package that communicates with both the CCD camera 100 and telescope 102. Currently, many systems utilize remote software packages such as this to serve as an interface to the various telescope systems and provide the user centralized control for tracking, acquiring images, processing images, and archiving data. If the functionality were to reside in a remote application such as this, then it would be independent of the hardware and only require software interfaces with the telescope 102, which are already utilized. Because of the more generic implementation and the common use of interface software for both the telescope 102 and CCD camera 100, this third embodiment is but one approach used in this project.

Because the hand controller is not needed for autonomous operation, this process could also run as a stand-alone software routine that communicates with the telescope 102 via the hand controller interface on the telescope 102 mount. The software would replicate the signal(s), protocols, or data formats used for the hand pad interface when the user manually aligns on a known initialization star. Thus, the telescope 102 would receive the same signal with autonomous alignment as it does with the prior art for manual alignment by a user with the hand controller. This software function could then run independent of (and simultaneous with) current user interface software packages if it is not incorporated into those packages. This embodiment does not depend on a hand controller, but specifically could utilize any of the external device inputs that are typically available on the go-to telescope mounts (such as RS 232, USB, etc.)

One embodiment incorporates the innovation with existing user interface software. This would maintain the fully centralized character of the interface software. However, the independent software implementation is an attractive embodiment because it can be used in conjunction with any user interface or even without a software interface as an independent process.

Supportive theory of the several star identification algorithms are demonstrated and documented in the engineering literature. A variation of these methods that takes into account the ground implementation aspects will be used in this innovation. A variation of this technology was used by NASA on the Astro-1 and Astro-2 missions for Instrument Pointing System attitude determination.

The key to a general application is to deal with seeing and light pollution while utilizing any information that may be available. The star identification procedure utilizes relative magnitude and relative locations of bright stars in a CCD image 106 to compare with a database to uniquely identify the stars in the image 116 along with the celestial coordinates of the identified stars. Key to this identification process is distinguishing between distributed objects (nebula, galaxies, and star clusters) and point objects. However, the brightness of an object 110 in the image will vary with seeing effects, in which case a range of variation in magnitude must be accounted for. Relative magnitude rather than absolute magnitudes can be used to identify comparison stars 110a-c of equal magnitude (within threshold) and angular separation. After accounting for suspected distributed objects, the image 106 will be integrated over several pixels to determine the intensity of the object as a means of removing the effects of seeing (which spreads the image over adjacent pixels). After the initial alignment is determined, the CCD camera 100 can be calibrated for seeing effects with stars of known magnitude to further improve the efficiency and accuracy of the identification algorithm. It should be noted that a variety of algorithms could be used with equal success. The innovation is not limited to the employment of a specific algorithm.

Once the magnitude and plate (x,y) coordinates of the bright objects are determined, the database will be searched for a unique match based on magnitudes, angle of separation 108a-c between bright objects, and number of objects in FOV. For the most general case of star identification, if the process does not uniquely identify the star field from one CCD image 106, then a mosaic of images will be constructed from contiguous images to increase

This system provides the capability for autonomous initial alignment of a telescope using CCD images 106. This innovation is more accurate as compared to manual processes because the alignment is based directly on image data 106 rather than intermediate measurements, thus eliminating errors in drive train, misalignments of axes, etc. In an alternate embodiment the image capture device is mounted to an instrument other than the telescope with the device mounted on a common mount but pointed distinctly. In that case the innovation would not be using the same image as the telescope sees and the potential for static misalignments could occur. This could be removed after manual inspection of one or a few images by adding an offset pointing bias. Since the alignment utilizes only the telescope and CCD images, it is more cost effective than the prior automated alignment process that requires additional hardware such as a GPS receiver and magnetic compass. This system is backward compatible with many existing telescopes 102 and image capture devices such as CCD cameras 100 requiring no hardware upgrades or additional/optional equipment.

The database parsing function restricts the search to a region of the sky based on estimates of the current orientation. The efficiency and accuracy of the estimate is related to the precision of the estimated orientation. Database parsing distinguishes this innovation from space star trackers that must search over the entire celestial sphere. Because the initialization will rarely be from a completely “lost-in-space” configuration, initial estimates may include at least one of: zip code; GPS data; user provided latitude and longitude; local time; estimated telescope drive angles; estimated RA 114 and Dec 112 of LOS. The feature utilizes the user's rough configuration data for low-end systems as well as incorporating information provided with high-end systems (such as GPS receivers). Finally, database parsing takes into account the reduced error associated with operational alignment updates. The capacity to update the alignment after a slew based on identifying stars 110 a-c in the image 106 is a unique feature that enhances the robustness of the autonomous operations. The prior art accommodates pointing error by slewing to and aligning on a bright “guide-star” near the target. Because post-slew operational star identification does not depend on guide-stars, the star field in the image is identified and the alignment updated regardless of the accumulated pointing error. This eliminates becoming “lost-in-space” when the guide-star is not acquired and is much less dependent on the tedious and time-consuming process of guide-star selection. Rather than simply matching patterns between two images, a general star identification is performed over any region of the sky, even encompassing the entire portion of the sky visible at a particular location and time. Robustness for accurate identification is gained by the ability to assemble a mosaic of images that effectively increases the FOV of the image 106 if needed. This innovation can be implemented as an added feature to CCD camera control systems as a user aid (such as identifying image field associated with asteroid or supernova search surveys) or as a stand-alone application.

The present invention, as disclosed herein, substantially enhances current telescope systems and provides a significant market advantage to the clients who implement it. There are several potential embodiments of the technology that could affect how it is marketed. For example, a CCD camera manufacturer could incorporate this function into the CCD camera control software and directly communicate the celestial coordinates of an image to the telescope control system (essentially replacing the manual keystroke entry with a signal containing the coordinates of the LOS). If the innovation were implemented as an added feature to CCD camera control systems, it could function as a user aid for identifying the objects in an image (such as asteroid or supernova search surveys).

If the functionality were associated with the telescope 102, the telescope 102 control computer could acquire the image data from the CCD camera 100 (over a serial link for example) and perform the star identification procedure as part of the alignment process. This would shift the computational burden to the telescope 102, but the processor in the telescope control system is quite capable of this task.

With the preferred embodiment, the function could reside in an interface software package that communicates with both the CCD camera 100 and telescope 102 which resides on a remote computer. Currently, many Systems utilize remote software packages such as this to serve as an interface to the various telescope systems and provide the user centralized control for tracking, acquiring images, processing images, and archiving data. If the functionality were to reside in a remote application such as this, then it would be independent of the hardware and only require software interfaces with the telescope control system software to utilize the information transmitted from the remote processor (over a serial line for example) in the place of manual telescope keypad entries. Because of the more generic implementation, this third embodiment is the preferred approach to be pursued in this project.

Finally, the star identification alignment process could be a dedicated piece of software communicating with the telescope mount via the hand controller interface. In this case, any entrepreneur could market this product.

While innovation illustrated and described it is to be understood that these are capable of variation and modification and therefore are not to be limited to the precise details set forth, but shall include such changes and alterations as fall within the purview of the following claims.

1. A method for identifying celestial objects comprising the steps of:
I. providing a telescope;
II. determining initial configuration data of the telescope;
II. slewing the telescope to a predetermined drive axis orientation;
III. providing an image capture device;
IV. capturing an image for star identification;
V. providing a star field database;
VI performing star identification process, utilizing the star field database;
VII. deriving relative coordinates from an identified star;
VIII. providing a telescope-pointing system;
VIII. providing to the telescope-pointing system the derived relative coordinates; and
IX. aligning the telescope utilizing the telescope-pointing system.

2. The method for identifying celestial objects as set forth in claim 1 wherein the step of determining the initial configuration of the telescope comprises at least one of the following:
a. providing an interface and allowing a user to input a zip code;
b. providing a satellite based positioning system which provides location information;
c. providing a terrestrially based positioning system which provides location information;
d. manually providing latitude and longitude;
e. manually providing local time;
f. providing estimated telescope drive angles;
g. estimated right ascension and declination of telescope line of sight

3. The method for identifying celestial objects as set forth in claim 1, wherein the step of slewing the telescope to a scheduled target orientation includes the steps of scheduling two initial target orientations as initial alignment orientations.

4. The method for identifying celestial objects as set forth in claim 3, wherein the first initial target orientation is approximately 45 degrees from the horizon in the northwest direction and the second alignment orientation is 45 degrees from the horizon in the northeast direction.

5. The method for identifying celestial objects as set forth in claim 4, wherein the initial target orientations can be commanded based on the a priori knowledge of the telescope orientation in terms of right ascension and declination drive axis angles relative to north and the horizon.

6. The method for identifying celestial objects as set forth in claim 1, further comprising the step of performing an automated focus on the captured image.

7. The method for identifying celestial objects as set forth in claim 5, wherein the star field database is parsed based on the celestial coordinates of the estimated field of view.

8. The method for identifying celestial objects as set forth in claim 7, wherein for initialization orientations, the size of an initial region of the sky is based on the estimated accuracy of the initial configuration estimates.

9. The method for identifying celestial objects as set forth in claim 8, wherein the size of the initial region includes the actual field of view of the telescope.

10. The method for identifying celestial objects as set forth in claim 8, wherein during viewing operations alignment updates will be more accurate and smaller search regions are used.

11. The method for identifying celestial objects as set forth in claim 8, wherein during the step of acquiring an image for star identification, the length of integration time used by the image capture device will depend on at least one of:
the image capture device; and
the telescope.

12. The method for identifying celestial objects as set forth in claim 11, wherein the integration time is sufficient time to record enough bright stars in the image for identification purposes.

13. The method for identifying celestial objects as set forth in claim 12, wherein the integration time is user specified in a configuration file.

14. The method for identifying celestial objects as set forth in claim 1, wherein a mosaic image is acquired with a larger field of view for the search.

15. The method for identifying celestial objects as set forth in claim 1, wherein the telescope is slewed to a different orientation.

16. The method for identifying celestial objects as set forth in claim 15, wherein the different orientation is about 10 degrees along at least one axis.

17. The method for identifying celestial objects as set forth in claim 1, wherein the image capture device is a selected from one of the following:
a CCD camera; and
a CMOS camera.

18. An autonomous system for pointing a telescope comprising:
an image capture device;
a processing and identification protocol;
a star field database;
a pointing processor;
a pointing control system;
a user interface; and
a telescope;
wherein the image capture device is configured to capture an image of at least two celestial objects; is configured to convey that image to the processing and identification protocol; the image is processed and associated with a unique set of data in the star field database and the pointing processor is then configured to process:
the unique set of data;
a signal from the pointing control system, said signal providing the pointing direction of the image capture device; and
input from the user interface to the pointing system; and
the output of the pointing processor is sufficient to point the telescope toward a predetermined celestial object.

19. The autonomous system for pointing a telescope of claim 18 wherein at least one of:
the processing and identification protocol;
the star field database; and
the pointing processor;
is implemented in the pointing control system;

20. The autonomous system for pointing a telescope of claim 18 wherein at least one of:
the processing and identification protocol;
a star-field database; and
the pointing processor;
is implemented in the image capture device; and
the system includes a:
pointing mount; and
a drive system; and
wherein the pointing mount and drive system aid in physically positioning the telescope.
